(19) United States
(12) Patent Application Publication
(10) Pub. No.: US 2006/0161475 A1
(43) Pub. Date: Jul. 20, 2006

(54) Method for private distribution of printed advertising material

(76) Inventors: Dale E. Redford, Grand Prairie, TX (US); Floyd W. Worth II, Richardson, TX (US)

Correspondence Address: Philip G. Meyers Law Office, Suite 300, 1009 Long Prairie Road, Flower Mound, TX, 75022, US

(21) Appl. No.: 10/815,491

(22) Filed: Apr. 1, 2004

(51) Int. Cl. G06Q 30/00

(52) U.S. Cl. 705/14

(57) ABSTRACT

A method for private distribution of printed advertising materials includes the steps of: (a) receiving at a publishing house an order from a customer for direct distribution advertising materials intended for distribution to recipients, (b) creating the advertising materials at the publishing house, (c) repeating steps (a) and (b) for a plurality of customers, (d) transporting the advertising materials created pursuant to (a)-(c) to one of a number of distribution centers associated with predetermined delivery regions, (e) bundling the sorted advertising materials so that advertising materials created for different customers for delivery to a single recipient address are grouped together, (f) dividing the packaged advertising materials up into delivery groups based on a predetermined delivery scheme, (g) providing a delivery group to each of a number of delivery couriers; and (i) hand delivering by the delivery couriers the sorted, packaged advertising materials to the recipients according to the delivery scheme.

### TECHNICAL FIELD

The invention relates to the creation and distribution of advertising materials such as brochures, flyers, catalogs and similar advertisements and, in particular, a method of distributing such materials through privately operated entities as opposed to a national postal service.

### BACKGROUND OF THE INVENTION

Each day, millions of pieces of printed advertising are distributed to consumers, primarily though public postal services, such as the United States Postal Service (USPS). Although businesses have relied almost exclusively on the USPS to deliver printed advertising to consumers, the cost of distributing such advertisements through public postal services has increased over the years while the volume of printed advertisements distributed has increased. Although some advertisements are privately distributed on an ad hoc local basis, there is no system in place that businesses may utilize for private distribution of printed advertisements. As used herein, the term “private distribution” refers to distribution of printed advertisements by business entities in the private sector and excludes national postal services such as the USPS.

Private distribution of printed advertisements is particularly suited to “national” or “regional” businesses that not constrained to serving a customer base in a limited area. As used herein, a “regional” or “national” business is one that utilizes high quality printed advertising materials distributed to customers and potential customers on a regional or national basis. In some cases these businesses will have numerous stores or outlets scattered across a country or a region, each providing essentially the same goods or services at each location. In other cases, regional or national businesses take orders via mail, telephone or over the Internet from one or a limited number of centers from which the goods are shipped to the customer. In many cases, such businesses rely on printed advertising materials distributed to consumers on a regional or national basis.

Alternatively a “local” business is one that serves a limited geographical area due to the nature of the goods and services provided by the business. Examples of such local businesses may include fast food restaurants, pet stores, pizza parlors, hair salons, automobile repair shops, and similar enterprises that draw their customers from a limited geographical area surrounding the business' location. Consequently, advertising by local businesses is normally confined to the limited geographical area where the business' customers are located. Even in the case of local businesses, distribution of printed advertisements is done almost exclusively by the USPS.

### SUMMARY OF THE INVENTION

In a first variation, a method for private distribution of printed advertising materials includes the steps of: (a) receiving at a publishing house an order from a customer for direct distribution advertising materials intended for distribution to recipients, (b) creating the advertising materials at the publishing house, (c) repeating steps (a) and (b) for a plurality of customers, (d) transporting the advertising materials created pursuant to (a)-(c) to one of a number of distribution centers associated with predetermined delivery regions, (e) bundling the sorted advertising materials so that advertising materials created for different customers for delivery to a single recipient address are grouped together, (f) dividing the packaged advertising materials up into delivery groups based on a predetermined delivery scheme, (g) providing a delivery group to each of a number of delivery couriers; and (i) hand delivering by the delivery couriers the sorted, packaged advertising materials to the recipients according to the delivery scheme.

In this regard, a “publishing house” refers generally to a printer or publisher, a “customer” is a regional or national business that utilizes printed advertisements such as brochures and catalogues, a “distribution center” is an entity that receives, sorts and packages the printed advertisements for distribution and “recipient” is a consumer or potential consumer of the advertised goods or services. As used herein, “delivery courier” refers to a private delivery service that is not associated with a national postal service.

In another aspect, the method includes sorting advertising materials created pursuant to different customer orders by intended recipient address. In this regard, the advertising materials created pursuant to different customer orders are sorted at the publishing house, the advertising materials being sorted in accordance with a delivery scheme utilizing one or more private delivery services in one or more delivery regions.

In another variation, advertising materials created pursuant to different customer orders may be sorted at the distribution facility in accordance with a delivery scheme utilizing one or more delivery services in the delivery area where the distribution center is located. In this regard, the advertising materials may be sorted by recipient address, which addresses are within the delivery region served by the particular distribution center. Preferably, the sorted advertising materials are placed in bags so that advertising materials created for different customers for delivery to a single recipient address are packaged in a single bag.

In another aspect, the method includes designing a delivery scheme based on one or more demographic factors whereby some possible recipients are deliberately omitted from the delivery scheme. Possible recipients may be omitted from the delivery scheme based on demographic factors such as geographical remoteness of recipient addresses or where the average income of recipients in a particular level does not meet a predetermined threshold value.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic representation of a system and method in accordance with a first variation of the method of the invention;

FIG. 2 is a second flow chart illustrating the steps in one variation of the method of the invention;

FIGS. 3 and 4 are schematic representations illustrating the geographical flow of printed advertisements in accordance with one variation of the method of the invention; and

FIG. 5 is a schematic representation of a system and method in accordance with a second variation of the method of the invention.

### DETAILED DESCRIPTION

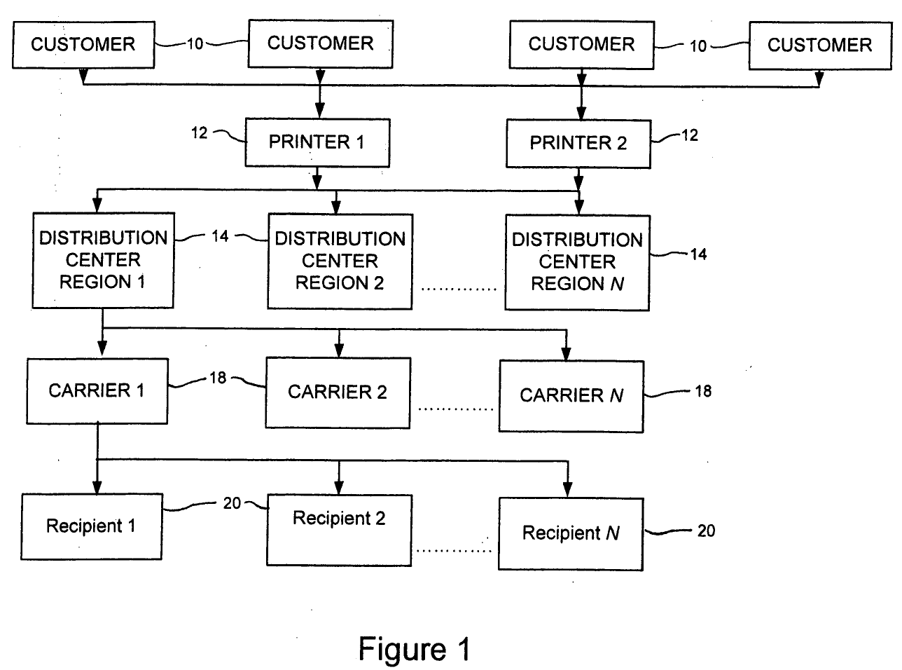

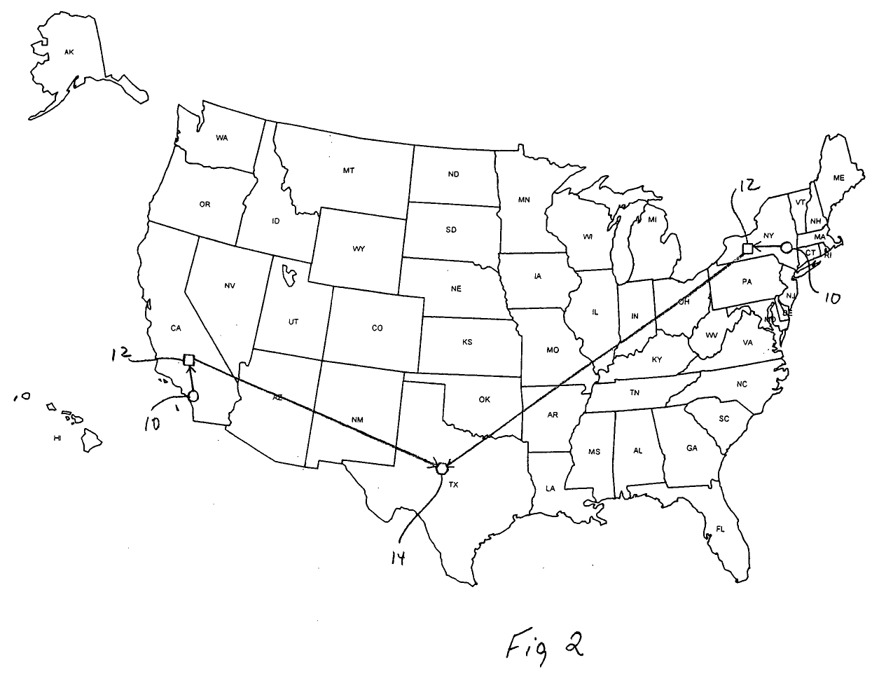

Referring to FIGS. 1 and 2, in a method according to the invention, a customer 10 submits a request to a publishing house or printing facility 12 for production of a printed advertisement such as a brochure, flyer or catalog. The request may include a proof or example of the advertisement, photos, drawings, price lists, text, the desired format of the advertisement, and any other materials to be used in formatting, laying out and printing the advertisement. In the case of a targeted distribution to selected consumers or potential consumers, customer 10 may also provide address information to be printed on the advertisement or on a label to be applied to the advertisement. As used herein, the term “customer” refers to a entity that utilizes printed advertisements distributed to consumer recipients to promote its products and/or services.

Customer 10 may also specify the type and grade of paper and other materials to be used in the production of the advertisement. In the case of a regional or national customer 10 that relies on high quality catalogs and brochures to market products, specialty paper, ink and processes are normally used to produce the advertising material. The constraint of having to use these speciality materials limits the number of publishing facilities that can produce high quality advertising materials for regional and national businesses. Consequently, these advertising materials are typically produced in large quantities and shipped by truck or otherwise to distribution centers.

Typically, customer 10 also submits a distribution plan to publishing house 12 along with the proof or copy, photos or drawings and related materials. The distribution plan may be specific, in which case the advertisement may be directed to specific addresses based upon a consumer or recipient 20 address list supplied or purchased by the customer 10. Alternatively, the distribution plan or scheme may target specific areas selected on demographic information, such as average income level, age or similar criteria. Alternatively the distribution plan may be non-specific, in which case customer 10 may simply specify a number of copies to be distributed to all recipients in a selected region or on a national basis. In most cases, however, due to the expense involved in preparing and printing high quality advertising materials, the advertisements will be targeted to specific consumers or potential consumers that have been previously identified.

The distribution plan or scheme may also incorporate other factors such as the geographical remoteness of one or more consumers or potential consumers. The number of consumers or potential consumers in a particular area may not justify the cost of private distribution of printed advertisements, even when other demographic factors are met. The number of potential consumers a particular geographic area may be more or less of a factor depending upon the cost of the printed advertising materials and the expected response to the advertisements. In this regard, the average income of consumers in a particular geographic area may be a factor determining whether private distribution is desirable. One possible way of determining a threshold criteria for deciding whether private distribution is economically feasible is determining the number of consumers or targeted consumers C, per mile of travel M required to distribute the printed advertising. In this scenario, as long as the ratio of C/M falls above a predetermined level, private delivery of printed advertising may be viable from a financial standpoint.

After receiving the advertising materials and/or directions from customer 10, publishing house 10 prepares the advertisements. Preferably, in the case of advertisements directed to specific consumers, the advertisements are created in address-based batches which may be corresponding to the regions and/or delivery areas for which the advertisements are destined. After the advertisements have been prepared, the advertisements are grouped in batches according to the region or regions where the advertisements are to be delivered and transported to one or more distribution centers 14, each of which serves a region or one or more delivery areas.

Alternatively, identical advertisements may be prepared in batches for non targeted distribution to consumers in one or more regions and/or delivery areas in a region. For example, a customer may order 20,000 identical brochures to be prepared for distribution to homes in River Hills, Wis. In this case, the advertisements are prepared in no particular order and batches for delivery to distribution centers 14 are assembled by taking the quantity needed for distribution at a particular time from those printed for distribution until the supply is depleted. In this scenario, after the advertisements have been assembled into batches by region or regions, the advertisements are shipped to one or more distribution centers 14 in the selected regions and/or delivery areas.

At distribution center 14, the advertising materials are combined into delivery groups to be delivered to specific addresses or in the case of non targeted advertisements, to each address in a specified area such as a city, town, suburb or county. The sorting process may involve sorting schemes and equipment similar to those utilized out by the United States Postal Service, or may done on a more primitive basis where distribution center 14 simply takes one of each advertisement intended for a given region and combines the advertisements into batches. In this case, advertisements created for different customers 10 are grouped together in accordance with an address-based delivery scheme. Preferably, groups of advertisements destined for delivery to a single recipient are bound, wrapped or placed in bags. Preferably, the advertisements are packaged in bags produced from a transparent polyethylene or a similar polymer film have a thickness less than about two mils. In one variation, advertisements may be printed on the bags themselves, affording distribution center 14 another revenue stream.

In another variation, wherein distribution center 14 receives advertisements from a single source, it may be possible to conduct the batching operation at publishing house 12. For example, if publishing house 12 receives orders from four national or regional businesses or customers 10 destined for delivery in the same region, or on a national basis, the printer could create the advertisements in delivery batches, i.e., 1234 . . . 1234 . . . 1234 . . . 1234 rather than 1111 . . . 2222 . . . 3333 . . . 4444 . . . wherein 1-4 represents the first, second, third and fourth businesses' advertisements, respectively. In this variation, the advertisements may be pre sorted by region, by the particular private delivery services 16 to be used and/or by recipient address.

After the sorting and packaging of the advertising materials at distribution center 14 is completed, the advertising materials are divided between and transported to one or more private delivery services 16 serving a particular geographic area. Since the private delivery services hand deliver the advertisements, the delivery process involves individual couriers or carriers 18 that walk or drive delivery routes. Consequently, an individual private delivery service 16 typically serves a limited geographical areas such as a single city or town, part of a city, and/or one or more suburbs of a city.

Private delivery service 16 divides the advertisements among individual carriers 18 that walk or drive a predetermined route. In the case of a mass distribution, the couriers or carriers 18 may simply walk through selected areas, delivering the advertisements to each address in the area. In the case of targeted advertisements, carriers 18 may walk predetermined delivery routes to deliver the advertisements to recipients 20 at selected addresses. In either case, the advertising materials are hand delivered to the recipients without the use of a public postal service.

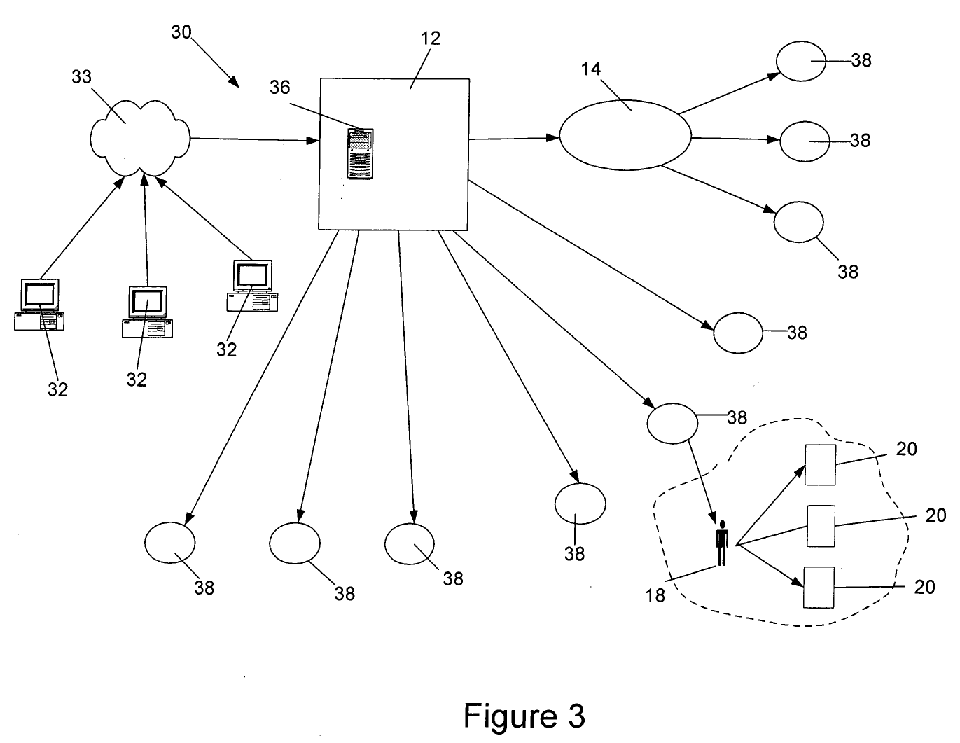

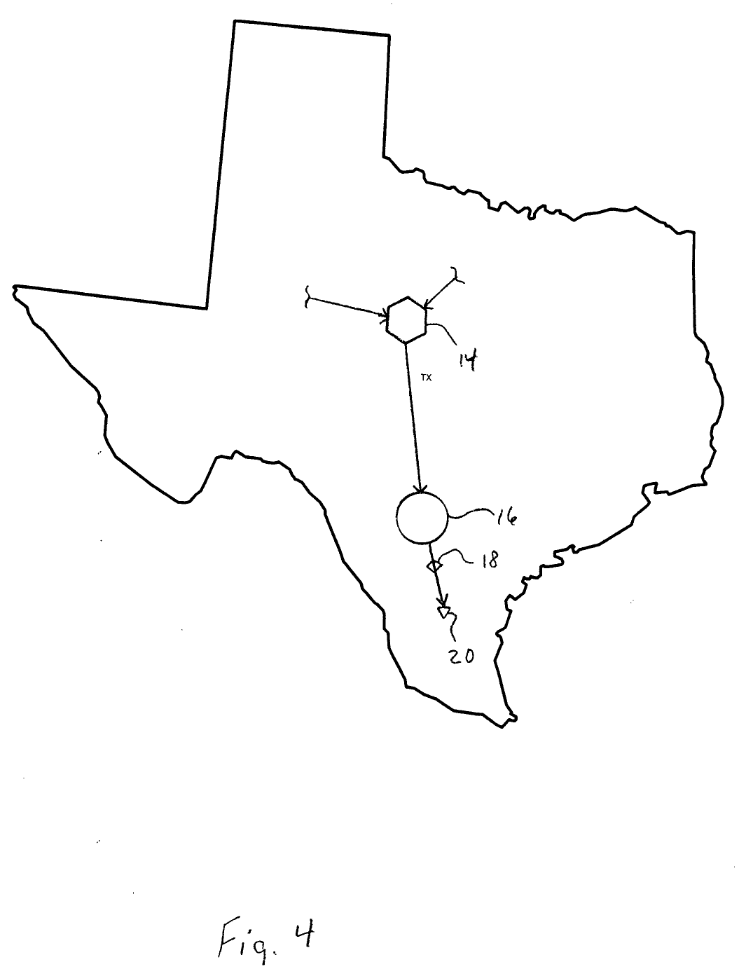

Referring to FIGS. 3 and 4, by way of example, customers 10 located in New York and California are each national mail order houses that distribute catalogs on a national basis to a selected or targeted group of recipients 20 across the United States. Each of customers 10 places an order for creation of a seasonal catalog with publishing houses 12. Customers 10 provide the publishing house with advertising proofs, text and a list of consumer recipients 20 to which the catalogs are to be delivered. Publishing houses 12 produces the catalogs in addressed based batches based upon the region in which the catalogs are to be distributed to consumers. The name and address of each recipient 20 is printed on each catalog or on a label applied to the catalog before the catalogs leave publishing house 12. For the purpose of illustration, one of the regions in which the catalogs are to be distributed is the state of Texas (FIG. 4).

Publishing houses 12 separates the address based batches of catalogs by region and ships the catalogs to distribution centers 14 in the regions in which the catalogs are to be delivered, including distribution center 14 located in central Texas. At distribution center 14, the catalogs are combined with other printed advertisements from other customers 10 and the combined advertisements are packaged in plastic bags for delivery to individual recipients 20. The packaged advertisements then sorted into batches or delivery groups corresponding to private delivery services 16 that deliver within different areas of the state and shipped to the private delivery services. In turn, private delivery service 16 sorts the packaged advertisements by carrier route for delivery by one or more carriers 18 who deliver the packaged advertisements to recipients 20 along his or her route. In this manner, the advertising materials are delivered to selected recipients without the involvement of a national postal service such as the USPS.

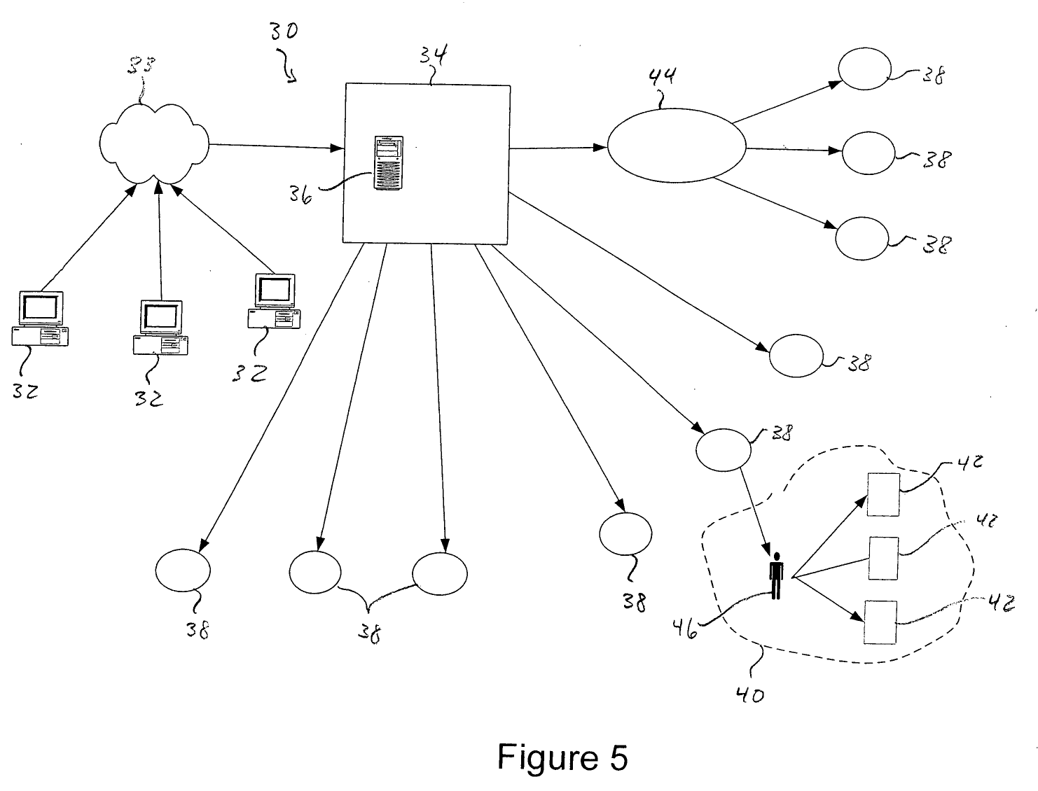

Referring to FIG. 5, one variation of the invention addresses the advertising needs of local merchants through the use of a network system 30. In this variation, local merchants utilize remote computer terminals 32 to access a publishing house or local printer 34 via the Internet 33 to place orders for privately distributed printed advertisements. The merchant may transmit copy for the printed advertisements or use previously prepared copy stored on the publishing house computer 36. The merchant may also specify a delivery scheme for delivery of the advertisements to selected areas, to selected recipients or a combination thereof.

Unlike regional and national businesses that typically use specialized paper and processes to produce high quality advertising materials, a local merchant may seek production of a maximum number of advertisements at the least possible cost. In these cases, the local merchant may utilize local printers that can produce an acceptable, but low cost, printed advertisement, such as a flyer on inexpensive paper. In this scenario, the merchant will typically specify a delivery scheme that blankets all addresses within one or more specified area(s). For example, a pizza pallor may specify that a flyer be delivered to all residential addresses within ten miles of the business' location.

Upon receipt of the order at the printer 34, a number of options are available. First, if the number of copies is large enough and the distribution area is small enough, printer 34 may simply print the advertisement and forward it to one or more private delivery services 38. This scenario assumes that the population density of the distribution area is such that the distribution of the advertisement is economically feasible based upon the price that the merchant is willing to pay.

A second alternative involves holding the merchant's order until such time as other merchants place orders to be delivered in the same area. In this variation, advertisements for a number of merchants would be held and combined. When orders for a sufficient quantity of advertisements for a given geographical area are accumulated, printer 34 prints and batches the advertisements together for delivery within the specified geographical area(s).

In yet another variation, printer 34 may coordinate with private delivery service 38 to provide regularly scheduled deliveries of advertisements to specified geographical areas. In this variation, merchants would be afforded an opportunity to place orders to have advertisements printed and delivered in accordance with the delivery schedule for the selected area or areas. Printer 34 and/or private delivery service 38 could, of course, make scheduled creation and delivery of the printed advertisements contingent upon receiving sufficient orders to make the scheduled delivery economically feasible.

In yet another alternative, local merchants would be allowed to place a bid with printer 34 to have an advertisement produced and distributed within a given geographic area serviced by printer 34 and private delivery service 38. If the total of the bids placed by the merchants reached a predetermined amount, then printer 34 will prepare the advertisements and arrange for private delivery service 38 to deliver the advertisements.

After printing, the advertisements are sorted and batched into groups according to a predetermined delivery scheme. The advertisements may be batched by either printer 34 or private delivery service 38, however it is believed that in most cases it will be most feasible and economical for printer 34 to sort the advertisements using an address based delivery scheme. In most instances it will also be preferable to package the advertising materials in a plastic bag for delivery. The printed advertisements are then transported directly to one or more private delivery services 38, each of which is responsible for delivering the advertisements within a given area 40. Alternatively in the case where multiple delivery services are used over a larger area, the advertisements may be transferred to a distribution center 44 where the advertisements are distributed to a number of private delivery services 38 for distribution in the desired area or areas.

If the printed advertisements have not been sorted by printer 34, the advertisements are then sorted and batched together by distribution center 44 or by private delivery service 38 for delivery to recipients 42 in the desired area or areas and packaged. If more than one private delivery service 38 is utilized to distribute the advertising materials, the packaged advertisements are sorted into delivery groups by delivery service 38 or distribution center 44 according to a delivery scheme utilizing multiple private delivery services 38. The delivery groups are then distributed to the private delivery service or services 38 which in turn, sort the packaged advertisements into groups to be hand delivered by carriers 46 to recipients 42.

Although several embodiments of the present invention have been described in the foregoing detailed description and illustrated in the accompanying drawings, it will be understood by those skilled in the art that the invention is not limited to the embodiments disclosed but is capable of numerous rearrangements, substitutions and modifications without departing from the spirit of the invention.

1. A method for private distribution of printed advertising materials, comprising:
(a) receiving at a publishing house an order from a customer for direct distribution advertising materials intended for distribution to recipients;
(b) creating the advertising materials at the publishing house;
(c) repeating steps (a) and (b) for a plurality of customers;
(d) transporting the advertising materials created pursuant to (a)-(c) to one of a number of distribution centers associated with predetermined delivery regions;
(e) bundling the sorted advertising materials so that advertising materials created for different customers for delivery to a single recipient address are grouped together;
(f) dividing the packaged advertising materials up into delivery groups based on a predetermined delivery scheme; and
(g) providing a delivery group to each of a number of delivery couriers; and (i) hand delivering by the delivery couriers the sorted, packaged advertising materials to the recipients according to the delivery scheme.

2. The method of claim 1, further comprising designing a delivery scheme based on one or more demographic factors whereby some possible recipients are deliberately omitted from the delivery scheme.

3. The method of claim 2, wherein a demographic factor is geographical remoteness of a recipient address.

4. The method of claim 2 wherein a demographic factor is the average income of recipients.

5. The method of claim 1 further comprising, sorting advertising materials created pursuant to different customer orders by intended recipient address.

6. The method of claim 5 wherein advertising materials created pursuant to different customer orders are sorted at the publishing house, the advertising materials being sorted in accordance with a delivery scheme utilizing one or more private delivery services in one or more delivery regions.

7. The method of claim 5 wherein advertising materials created pursuant to different customer orders are sorted at the distribution facility in accordance with a delivery scheme utilizing one or more delivery services in the delivery area where the distribution center is located.

8. The method of claim 7 wherein the advertising materials are sorted by recipient address, which addresses are within that delivery region.

9. The method of claim 1 wherein the sorted advertising materials are placed in bags so that advertising materials created for different customers for delivery to a single recipient address are packaged in a bag.

10. A method of distributing printed advertisements comprising:
providing a computer based system for receiving an order from a local merchant for the preparation and private distribution to recipients of printed advertisements within a specified geographical area;
printing the advertisements;
distributing the advertisements to a private delivery service to distribute the printed advertisements; and
utilizing the private delivery service to deliver the printed advertisements in a selected geographical area.

11. The method of claim 10 further comprising determining a delivery scheme for delivery of the advertisements.
